(19) United States
(12) Patent Application Publication
(10) Pub. No.: US 2026/0336360 A1
(43) Pub. Date: Oct. 29, 2026

(54) VALVE WITH INTEGRATED SENSOR UNIT

(71) Applicant: ZF Friedrichshafen AG, Friedrichshafen (DE)

(72) Inventors: Markus DIESCH, Bierstetten (DE); Dominik GULDENSCHUH, Freiburg (DE); Markus MOOSMANN, Grünkraut (DE); Tobias BISCHOFF, Tettnang (DE); Gebhard SCHMIDT, Meckenbeuren (DE); Florian PAWLAK, Eriskirch - Mariabrunn (DE); Uwe HEITZ, Markdorf (DE)

(21) Appl. No.: 19/660,934

(22) Filed: Apr. 28, 2026

(30) Foreign Application Priority Data
Apr. 28, 2025 (DE) 102025116270.0

(51) Int. Cl. B60H 1/00; F16K 37/00

(52) U.S. Cl. CPC B60H 1/00899; B60H 1/00485; F16K 37/005

(57) ABSTRACT

A thermal management system for a vehicle includes a first refrigerant circuit, such as part of a heat pump system having at least one compressor, a first heat exchanger, and a valve in the first refrigerant circuit. The valve includes a sensor unit integrated into the valve. The system optionally includes a first coolant circuit which passes through the first heat exchanger. The first heat exchanger is optionally an evaporator such that the first coolant circuit is optionally a low-temperature circuit. The system optionally includes a second heat exchanger and optionally includes a second coolant circuit which passes through the second heat exchanger. The second heat exchanger is optionally a compressor such that the second coolant circuit is optionally a high-temperature circuit.

### CROSS-REFERENCE TO RELATED APPLICATION

The present application is related and has right of priority to German Patent Application No. 10 2025 116 270.0 filed on Apr. 28, 2025, the entirety of which is incorporated by reference for all purposes.

### FIELD OF THE INVENTION

The present invention relates generally to a thermal management system, in particular for a vehicle, in particular an electric vehicle or a hybrid vehicle, to a valve, in particular an expansion valve for a thermal management system, to a vehicle which includes said thermal management system, and to a method for managing thermal loads in a vehicle.

### BACKGROUND

In present-day vehicle technology, in particular with respect to electric vehicles and hybrid vehicles, thermal management is of crucial significance. An essential integral part of an efficient thermal management system is the precise closed-loop control of the refrigerant circuits in order to ensure the optimal operating temperature of the various vehicle components. A problem known from the prior art is the necessity to accurately measure pressure and temperature within the refrigerant circuits in order to ensure that overheating is controlled in a safe and efficient manner. Traditionally, this requires the use of separate sensors which must be installed in the heat pump and electrically contacted.

The expansion valve in particular plays a decisive role in the thermal management system by reducing the pressure of the refrigerant, whereby said refrigerant may evaporate and provide the necessary cooling performance. An insufficiently operating expansion valve may lead to the refrigerant not evaporating completely, which adversely affects the efficiency of the system and leads to insufficient cooling performance. A poorly regulated expansion valve may lead to flooding of the evaporator, in particular when too much refrigerant enters the evaporator, which not only reduces the efficiency of the system but may also lead to damage to the components. An inefficiently operating expansion valve may increase the energy consumption of the system, which leads to higher operating costs and lower overall power of the heat pump.

Due to the requirement for increased installation space as a result of the integration of separate sensors and their wiring, additional space is required, which may be particularly problematic in compact vehicle designs r. The complexity of the electrical contacting, the necessity to establish a plurality of electrical connections, increases the complexity and the potential for error in installation and maintenance. The test effort, the testing and calibration of the individual components, requires additional effort and may increase the production costs. These challenges illustrate the need for an improved approach which allows for a more efficient integration of the sensors and simplified electrical contacting.

### SUMMARY OF THE INVENTION

A problem addressed by the invention is therefore that of overcoming the aforementioned problems and providing a thermal management system which is improved as compared to the prior art.

A further problem addressed by the invention is that of providing a thermal management system which is capable of precisely measuring and controlling, in a closed loop, the temperature and the pressure of the refrigerant in order to ensure optimal cooling performance and energy efficiency.

A person skilled in the art will understand that any embodiment described in the following description is covered and included by the subject matter of the accompanying claims. The embodiments, features, and combinations of features described in conjunction with the invention and the combinations of features indicated in the accompanying claims, but also any combination of features mentioned and described in conjunction with the embodiments, are considered to be disclosed herein, but at least derivable by a person skilled in the art. In particular, any feature and any combination of features in the embodiments described herein can be claimed, for example, in another combination, in particular in another claim category, at least because a person skilled in the art will recognize that any combination of the features mentioned herein is suitable for solving the underlying problem. Furthermore, any feature and any combination of features in the claims and in the following description can be used and claimed regardless of the particular claimed subject matter, regardless of claim dependencies and dependency references, and regardless of the claim category in which the feature is claimed.

The above-described problems are advantageously solved in a first aspect of the invention by a thermal management system according to the present invention. This thermal management system is particularly useful when it is used in a vehicle, in particular an electric vehicle or a hybrid vehicle.

The thermal management system according to the invention includes a first refrigerant circuit, which includes a cooling system, in particular a heat pump system having at least one compressor, a first heat exchange means or “first heat exchanger,” in particular an evaporator, optionally a second heat exchange means or “second heat exchanger,” in particular a condenser, and a valve, in particular an expansion valve.

According to the present invention, the valve, particularly an expansion valve, includes a sensor unit integrated into the valve, in particular expansion valve.

The integration of the sensor unit into the valve offers a plurality of substantial advantages. First, integrating the sensor unit makes it possible to precisely and immediately measure measurement variables, such as pressure and/or temperature, directly at the valve. This leads to improved closed-loop control and open-loop control of the refrigerant circuit, since the collected data may be processed in real time. Thus, the efficiency of the system is considerably increased. Secondly, the compact design of the integrated system contributes to the reduction in the required installation space. This is particularly advantageous in applications in which space is limited, for example in electric vehicles or hybrid vehicles. The reduction in installation space may also lead to reduced weight and thus to an improvement in the overall power of the vehicle. In addition, providing a valve with integrated sensor work simplifies the installation and maintenance of the system.

A thermal management system refers to a system which controls the temperature of at least two consumers. A consumer is therefore a device to be cooled or to be heated. One consumer may have to be cooled and one consumer may be a consumer to be heated. These consumers may even lie in a cooling circuit, as described below.

Controlling the temperature is understood in the present invention to mean cooling or heating.

Preferably, a consumer may be an electric machine. A consumer may also be an inverter. Additionally, or alternatively, a consumer may be a passenger compartment. Advantageously, a consumer may be a battery.

According to the present invention, a consumer may in particular also be an electrical consumer of the e-axle system, such as an electric motor and the power electronics system of the e-axle or the like.

The thermal management system has at least one coolant circuit. Preferably, the thermal management system has at least one refrigerant circuit and one coolant circuit. The refrigerant circuit has at least one cooling device, which cools the refrigerant. The coolant circuit is cooled via the refrigerant and is directly connected to at least one consumer.

In addition, the thermal management system may have at least two coolant circuits and one refrigerant circuit. In particular instances, the thermal management system may have precisely two coolant circuits. The refrigerant circuit has at least one cooling device, which cools the refrigerant. The coolant circuit is cooled via the refrigerant and is directly connected to the consumers.

Preferably, one of the coolant circuits may be a high-temperature circuit and the other coolant circuit may be a low-temperature circuit. The high-temperature circuit is thermally connected to the refrigeration circuit at a first point and the low-temperature circuit is thermally connected to the refrigeration circuit at a second point. The first point has a higher temperature than the second point. In particular, the high-temperature circuit may be connected downstream of a compressor. Preferably, the low-temperature circuit may be connected downstream of an expansion valve.

The temperature to which the high-temperature circuit may be cooled may be, for example, 40 °C. This temperature may be used at the same time to heat a consumer such as the passenger compartment and to cool another consumer such as an electric machine.

The low-temperature circuit is cooled to a lower temperature than the high-temperature circuit. Thus, the cooling performance may be concentrated on the low-temperature circuit, to which the greatest consumer of cooling, for example a power electronics system, is connected. Thus, the provision of the cooling performance is optimized and the compressor, for example, may be dimensioned smaller.

The low-temperature circuit may preferably include a radiator.

Advantageously, the high-temperature circuit may include a consumer which is a passenger compartment and/or an electric machine and/or a battery. In addition, the low-temperature circuit may include a power electronics arrangement, in particular an inverter.

The cooling device may be a heat pump. The heat pump includes at least two heat exchangers and one compressor. One of the heat exchangers may be a condenser and the other heat exchanger may be an evaporator.

Preferably, the refrigerant in the refrigerant circuit is a natural refrigerant, in particular propane. In addition, the coolant in the coolant circuit(s) may be a water-glycol mixture.

Preferably, the thermal management system has a distributing unit. The distributing unit may be used to control which circuit is connected to which circuit and to which consumer. The distributing unit is also referred to as a fluid control unit (FCU). The distributing unit advantageously has a valve unit with at least one valve. The valve may be a slide valve, in particular an axial slide valve or a rotary slide valve. In particular, the distributing unit may have at least four, preferably precisely four, valves.

The distributing unit may have at least two housing parts. Channel structures and/or valve receiving regions may be formed on the adjoining sides of the housing parts. Alternatively, one housing part may be a cover without structures and only one housing part may have channel structures and/or valve receiving regions. It is also conceivable to provide only valve receiving regions in one housing part and only channel structures in the other housing part.

In addition, the thermal management system has a pump arrangement with at least one pump. Preferably, the pump arrangement may have at least two pumps. In some instances, the pump arrangement may have precisely two pumps. At least one pump may be a gerotor pump. At least one pump may be a vane pump.

The thermal management system may alternatively be stationary, for example, in a building.

The aforementioned problems are also advantageously solved in a second aspect of the present invention by a vehicle, in particular an electric vehicle or a hybrid vehicle, which includes a thermal management system according to the present invention.

In this context, the integration of the thermal management system according to the present invention into a vehicle, in particular an electric vehicle or a hybrid vehicle, offers considerable technical advantages, including improved efficiency, reduced complexity and weight, improved cooling performance, simplified maintenance, and operational flexibility.

The aforementioned problems are also advantageously solved in a third aspect of the present invention by a valve, in particular an expansion valve according to the present invention, which includes an integrated sensor unit.

The aforementioned problems are also advantageously solved in a fourth aspect of the present invention by a method for managing thermal loads in a vehicle, in particular an electric vehicle or a hybrid vehicle, preferably having a thermal management system according to the present invention.

The method of the present invention includes at least the following steps. Providing a first refrigerant circuit, which includes a cooling device, in particular a heat pump. The first refrigerant circuit includes at least one compressor and a first heat exchange means, in particular an evaporator. The first refrigerant circuit optionally includes a second heat exchange means, in particular a condenser. The first refrigerant circuit includes a valve, which is preferably selected from the group including a valve in the refrigerant circuit, preferably a shut-off valve, a switch-over valve, or an expansion valve, in particular an expansion valve, which includes a sensor unit integrated into the valve.

The method according to the present invention includes a step of monitoring data, preferably regarding the thermal loads and/or pressures, of the refrigerant in the first refrigerant circuit, by the sensor unit.

The method according to the invention also optionally includes a step of controlling the valve, in particular expansion valve, for the closed-loop control of the refrigerant circuit, on the basis of the data collected by the integrated sensor unit, preferably regarding the thermal loads and/or pressures, of the refrigerant in the first refrigerant circuit.

The method according to the invention may also optionally include a step for circulating a coolant through the first coolant circuit, which is a low-temperature circuit, in particular a cooling water circuit, which flows through the first heat exchange means, in particular the evaporator.

The method according to the invention may also optionally include a step for circulating a coolant through the second coolant circuit, which is a high-temperature circuit, which flows through the second heat exchange means, in particular the compressor.

It is pointed out that the aforementioned steps do not necessarily need to be carried out in the order indicated. The indicated steps may be carried out in any other suitable order. The order indicated above may be advantageous, however, for certain embodiments of the method. For example, the data regarding the thermal loads and/or pressures of the refrigerant in the first refrigerant circuit may be monitored by the sensor unit prior to, after, cyclically, and/or during the open-loop control of the valve, in particular expansion valve, on the basis of the data regarding the thermal loads and/or pressures of the refrigerant in the first refrigerant circuit collected by the integrated sensor unit.

A person skilled in the art will immediately recognize that a feature, an embodiment, an effect, or an advantage described herein in conjunction with the thermal management system according to the invention may also be a feature, an embodiment, an effect, or an advantage of the method according to the invention, and vice versa.

Within the present application, terms such as “side” or “lateral”, “back”, “front”, “up”, “down”, “base”, “opposite”, “inside”, “outside”, or the like, which describe the position of a first object relative to another object, preferably relate to the relative position of a particular part or object with respect to its position when it has been fully mounted for its intended use.

The term “integrated sensor unit”, as used herein, preferably indicates that the valve includes a sensor unit which is installed directly in the valve. This sensor unit is not separate, but rather an integral part of the valve. It enables, in particular, the measurement of pressure and/or temperature directly at the valve and in the refrigerant circuit.

The integration of the sensor unit into the valve therefore offers a compact assembly for thermal management systems, which includes both valve and sensor unit. This is advantageous in particular since the integrated sensor unit enables precise and immediate measurement of data of the refrigerant, in particular pressure and/or temperature, directly at the valve. Thus, the closed-loop control and the open-loop control of the refrigerant circuit is considerably improved, which leads to higher efficiency of the entire thermal management system. In addition, the integration of the sensor unit reduces the required installation space and simplifies the installation and maintenance, since separate components and connections are necessary. This contributes to the reliability and durability of the system and makes it an attractive approach for modern applications, in particular in confined installation conditions such as in electric vehicles or hybrid vehicles.

In a preferred embodiment of the method according to the invention and/or of the valve according to the invention, in particular expansion valve, of the vehicle, and/or of the thermal management system, the integrated sensor unit includes a pressure sensor and/or a temperature sensor. It is to be understood that the sensor unit integrated into the valve may include one or more sensor(s) which collect identical or different data regarding the refrigerant. Various physical measurement variables are conceivable, wherein in particular pressure and temperature are important physical measurement variables of the refrigerant. The sensor unit may include a pressure sensor. This pressure sensor is designed to measure the pressure of the refrigerant. The integration of a pressure sensor into the sensor unit of the expansion valve is particularly advantageous since it enables precise and immediate measurement of the pressure of the refrigerant. The knowledge of the pressure of the refrigerant, preferably in real-time measurement, is important for the efficient closed-loop control and open-loop control of the refrigerant circuit.

Additionally, or alternatively, the sensor unit may include a temperature sensor. This temperature sensor is designed to measure the temperature of the refrigerant. The integration of a temperature sensor into the sensor unit of the valve enables the precise measurement of the temperature of the refrigerant.

In a further preferred embodiment of the method according to the invention and/or of the valve according to the invention, in particular expansion valve, of the vehicle, and/or of the thermal management system, the sensor unit, in particular the pressure sensor and/or the temperature sensor, is arranged at the valve inlet and/or at the valve outlet of the valve in the refrigerant circuit.

This is advantageous, in particular, since the arrangement of the sensor unit, in particular of the pressure sensor and/or of the temperature sensor, at the valve inlet and/or at the valve outlet enables precise and immediate measurement of the relevant operating parameters of the refrigerant. Due to the placement of the sensors at these critical points in the refrigerant circuit, accurate measurements of the pressure and temperature conditions may be carried out both upstream of and downstream of the valve.

The term “the sensor unit is arranged,” as used herein, preferably refers to the specific placement of the sensor unit within the refrigerant circuit of a thermal management system. According to the present invention, the placement is preferably at the specific location at which the measured value is recorded. This means that the sensor unit, which may include pressure and/or temperature sensors, is located at a certain position in the refrigerant circuit of the thermal management system in order to enable accurate measurements of the operating conditions of the refrigerant to be carried out at this location. Thus, the sensor unit, which may include for example pressure and/or temperature sensors, is positioned at a certain point in the system in order to enable optimal measurements of the operating conditions of the refrigerant to be carried out at this measurement point. It is also conceivable according to the invention that the sensor unit may include further components, electronics units, or connections, which are arranged at other locations of the valve assembly into which the sensor unit is integrated.

The sensor unit is preferably arranged at the valve inlet. This is advantageous in particular since the arrangement of the sensor unit at the valve inlet enables precise and immediate detection of the operating conditions of the refrigerant before it enters the valve. Due to the measurement of pressure and/or temperature at this point, accurate data regarding the state of the refrigerant prior to entry into the valve may be collected, which enables optimized closed-loop control and open-loop control of a refrigerant circuit.

It is also preferable that the sensor unit is arranged at the valve outlet. The arrangement of the sensor unit at the valve outlet permits precise and immediate detection of the operating conditions of the refrigerant after it has passed through the valve. Due to the measurement of pressure and/or temperature at this point, accurate data regarding the state of the refrigerant, in particular with an expansion valve after expansion, may be collected, which in turn enables optimized closed-loop control and open-loop control of the refrigerant circuit.

It is also possible that the sensor unit is arranged both at the valve inlet and at the valve outlet. The sensors may each be provided for detecting the same or different measurement variables. In other words, the temperature and the pressure, for example, may be measured at the valve inlet. Additionally, or alternatively, the temperature and the pressure may be measured at the valve outlet. It is also possible to measure the temperature at the valve inlet and the pressure at the valve outlet, or vice versa.

According to the present invention, the valve according to the invention is a valve which is preferably selected from the group including a valve arranged in the refrigerant circuit. This may preferably be a shut-off valve, a switch-over valve, or an expansion valve. An expansion valve is, according to the present invention, a particularly preferred embodiment which makes the present invention particularly advantageous.

A valve, in particular an expansion valve, according to the present invention is preferably a magnetically actuated valve.

A magnetically actuated valve offers the advantage of fast and precise open-loop control of the refrigerant flow, which leads to higher energy efficiency and improved system performance.

Alternatively, according to the present invention, the valve may preferably be a spring-loaded valve.

A spring-loaded valve is distinguished by its robustness and durability, which is advantageous in particular in applications with high pressure loads and continuous operation.

In a further preferred embodiment of the method according to the invention and/or of the valve according to the invention, of the vehicle, and/or of the thermal management system, the valve inlet and the valve outlet are arranged axially.

This axial arrangement allows for a compact design and straight fluid guidance, which facilitates installation in confined spaces and minimizes the flow resistance. Thus, the efficiency of the system is increased and the energy consumption is reduced. The valve preferably has a corresponding tube design, in which the structure of the valve ensures uniform distribution of the refrigerant.

Alternatively, other valve designs are also possible according to the present invention, however. In particular, the refrigerant may be supplied axially at the valve inlet and flow out radially at the valve outlet. According to the present invention, the valve outlet may therefore be arranged radially.

Similarly, the refrigerant may be supplied radially at the valve inlet and flow out axially at the valve outlet. According to the present invention, the valve inlet may therefore be arranged radially.

The valve according to the present invention may have both a normally closed configuration and a normally open configuration. This flexibility makes it possible to provide the valve according to the invention according to demand for different conditions depending on the specific requirements of the system. In the normally closed configuration, the valve may completely stop the flow of refrigerant, which is particularly useful for conserving energy and isolating the system when not in use. In the normally open configuration, in contrast, the valve may ensure continuous flow of refrigerant, which enables constant cooling and efficient heat transfer.

The valve, in particular the expansion valve, as a central integral part of the thermal management system, may thus be precisely controlled in a closed loop by a control unit. Such a control unit may be included in the thermal management system according to the invention and/or in the vehicle. It is preferably designed to monitor various parameters such as temperature and/or pressure in the refrigerant circuit.

In a thermal management system, in particular a heat pump, pressure and temperature must be measured in order to ensure that overheating is controlled in a safe manner. These sensors must be appropriately installed in the heat pump and electrically contacted. The control unit is therefore typically connected to a plurality of sensors which may be mounted at strategic points in the system such as at the evaporator outlet or at the compressor inlet. This also includes, according to the invention, the sensor unit integrated in the valve. Preferably, the control unit is designed to control the opening and closing of the valve in a closed loop on the basis of the data collected by the sensor unit in order to optimally regulate the flow of refrigerant. These sensors collect data, preferably in real time, which are transmitted to the control unit. The control unit processes this information and transmits appropriate signals to the valve in order to adapt the position thereof.

The valve itself is connected to the control unit via electrical connections. This connection enables fast and precise open-loop control of the valve, which leads to a more efficient closed-loop control of the refrigerant flow. Via the interface, diagnostic data and performance parameters of the valve may also be transmitted, which enables comprehensive monitoring and optimization of the thermal management system.

In a further preferred embodiment of the method according to the invention and/or of the valve according to the invention, of the vehicle, and/or of the thermal management system, the valve has an interface which is designed to transmit data and/or performance of the valve and of the integrated sensor unit.

This is advantageous in particular since the interface of the valve is designed to transmit data and/or performance both of the valve and of the integrated sensor unit. This embodiment as a common assembly enables simplified installation and maintenance, since only one single connection is necessary for the entire assembly. In particular, the assembly is one single testable unit. This reduces the wiring complexity and minimizes potential fault sources. Via the interface, various functions may be realized, such as monitoring and controlling the flow of refrigerant, collecting and transmitting pressure and temperature data, and adapting the valve position on the basis of the collected sensor data. Thus, precise closed-loop control of the thermal management system is enabled, which leads to higher efficiency and reliability of the entire system.

### BRIEF DESCRIPTION OF THE FIGURES

The present invention is explained in greater detail in the following with reference to the drawings, from which further features, embodiments, and advantages may be gathered. In the embodiments shown in the figures, elements that have similar or identical functions are provided with the same reference characters. It is pointed out that the figures are possibly not true to scale with respect to one another.

In the drawings:

FIG. 1 shows a schematic flow diagram of a thermal management system according to a first embodiment according to the invention; and

FIG. 2 shows a schematic view of an expansion valve according to the first embodiment according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

The features of the present invention disclosed in the description, the claims, examples, and/or the figures may be essential, both individually and in any combination, for realizing the invention in various embodiments. In the embodiments shown in the figures, elements that have similar or identical functions are provided with the same reference characters. It is pointed out that the figures are possibly not true to scale with respect to one another.

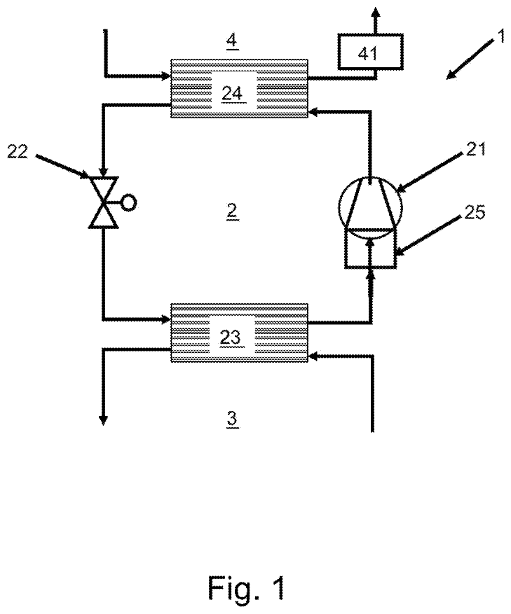

FIG. 1 shows a thermal management system according to a first embodiment according to the invention, which is particularly usable in a vehicle, such as in standard combustion engine vehicles or electric vehicles or hybrid vehicles. A thermal management system of this type generally includes a refrigerant circuit 2 having a cooling system 1, such as a heat pump system 1 in the present case. The heat pump 1 functions by compressing refrigerant using the compressor 21, whereby the pressure and the temperature of the refrigerant are increased. The compressor 21 is driven by an electric machine 25 in some instances. The heated refrigerant then flows through a second heat exchange means 24, in particular a condenser 24, where it releases heat to the high-temperature circuit 4 and condenses to form a liquid. The liquid refrigerant then passes through a valve 22, where it undergoes a pressure drop and cools down considerably. The cooled refrigerant then enters a first heat exchange means 23, in particular an evaporator 23, where it absorbs heat from the low-temperature circuit 3, whereby it evaporates and completes the cycle.

This means there are two coolant circuits 3, 4 in this example. The first coolant circuit 3, which is the low-temperature circuit 3, in particular a cooling water circuit, enables the coolant to flow through the evaporator 23. This circuit 3 is responsible for ensuring that the refrigerant in the circuit 2 absorbs heat from the coolant in the low-temperature circuit 3 and thus cools the coolant in the circuit 3, which may thus cool the consumers connected to this circuit 3. The second coolant circuit 4, which is a high-temperature circuit 4, enables the coolant to flow through the condenser 24. This circuit is designed to conduct the heat from the refrigerant in the circuit 2 into the high-temperature circuit 4 and thus warm and heat the consumers connected to the high-temperature circuit 4. In the present case, the high-temperature circuit 4 includes an additional heater 41, for example a PTC heater 41.

The valve 22 is an expansion valve 22 according to the present invention.

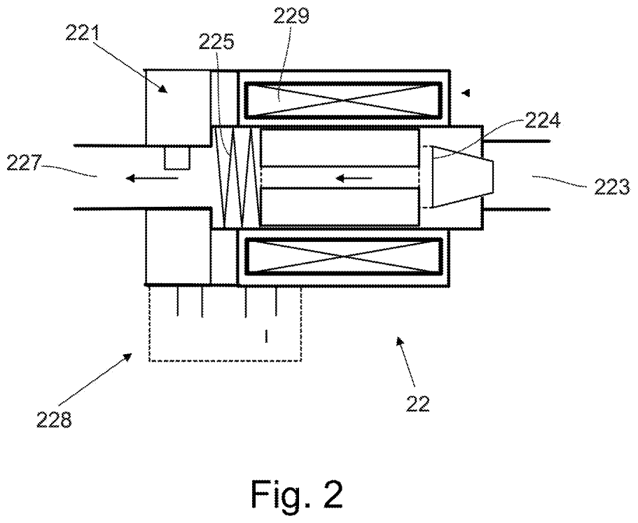

FIG. 2 shows a schematic design the expansion valve 22 according to a first embodiment according to the invention. It is to be understood that, according to the invention, the valve 22 according to the invention is any valve that is arranged in the refrigerant circuit. This valve 22 is preferably a shut-off valve, a switch-over valve, or an expansion valve. An expansion valve is, according to the invention, a particularly preferred embodiment which makes the present invention particularly advantageous, and therefore the embodiment shown in FIG. 2 relates to an expansion valve.

The expansion valve 22 includes an integrated sensor unit 221. The integrated sensor unit 221 includes a pressure sensor and a temperature sensor, which are arranged at the valve outlet 227 in the refrigerant circuit 2. An additional or alternative arrangement at the valve inlet 223 is also conceivable. The expansion valve 22 shown in FIG. 2 is a magnetically actuated expansion valve 22, which is actuated by the magnetic coils 229. Additionally, it has a spring 225, which supports the valve and presses said valve onto the valve seat 224. In other words, the valve 22 shown has a normally closed configuration. In the represented embodiment, the valve 22 also has a tube design (e.g., is tubular) and the valve inlet 223 and the valve outlet 227 of the expansion valve 22 are arranged axially, which permits a particularly compact shape. Optionally, the valve inlet 223 or the valve outlet 227 may be arranged radially.

The expansion valve 22 has an interface 228, which is designed to transmit data and/or performance of the expansion valve 22. At the same time, the interface 228 is provided for also transmitting data and/or performance of the integrated sensor unit 221. Thus, the expansion valve 22 with an integrated sensor unit 221 may be provided as a single assembly having a common interface 228.

With this represented expansion valve 22 according to the present invention, in particular, a method for managing thermal loads in a vehicle, in particular an electric vehicle or a hybrid vehicle, preferably having a thermal management system according to the present invention, is implemented.

Initially, a thermal management system as represented in FIG. 1 is provided. The coolant circulates through the first coolant circuit 3, which is a low-temperature circuit, in particular a cooling water circuit, which flows through the first heat exchange means 23, in particular the evaporator 23. In addition, the coolant circulates through the second coolant circuit 4, which is a high-temperature circuit, which flows through the second heat exchange means 24, in particular the condenser 24. The sensor unit 221 monitors data, preferably data of the thermal loads and/or pressures, of the refrigerant in the first refrigerant circuit 2. By a control unit, the expansion valve 22 is regulated for the closed-loop control of the refrigerant circuit 2 on the basis of the data collected by the integrated sensor unit 221, preferably regarding the thermal loads and/or pressures, of the refrigerant used in the first refrigerant circuit 2.

The embodiments represented in the figures can relate to preferred embodiments, whereas all elements and features described in conjunction with embodiments can be used, where appropriate, in combination with any other embodiment and any other feature, as described herein, in particular with respect to any other further embodiment discussed above.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1: cooling system, heat pump system
2: first refrigerant circuit
21: compressor
22: expansion valve
222: inlet side
223: valve inlet
224: valve seat
225: spring
226: outlet side
227: valve outlet
228: communication interface
229: magnetic coil
23: evaporator
24: condenser
25: electric machine
3: low-temperature circuit, first coolant circuit
4: high-temperature circuit, second coolant circuit
41: PTC heater

1.-10. (canceled)

11. A thermal management system for a vehicle, comprising:
a first refrigerant circuit (2) comprising:
at least one compressor (21);
a first heat exchanger (23); and
a valve (22) in the first refrigerant circuit (2), the valve (22) comprising a sensor unit (221) integrated into the valve (22).

12. The thermal management system of claim 11, the sensor unit (221) comprising one or both of a pressure sensor or a temperature sensor.

13. The thermal management system of claim 11, wherein the sensor unit (221) is at one or both of a valve inlet (223) or a valve outlet (227) in the first refrigerant circuit (2).

14. The thermal management system of claim 11, wherein the valve (22) is one or both of a magnetically actuated valve or a spring-loaded valve.

15. The thermal management system of claim 11, wherein a valve inlet (223) and a valve outlet (227) of the valve (22) is arranged axially.

16. The thermal management system of claim 11, wherein one or both of a valve inlet (223) or a valve outlet (227) of the valve (22) is arranged radially.

17. The thermal management system of claim 11, wherein the valve (22) comprises an interface (228) for transmitting data or performance of the valve (22) and of the sensor unit (221).

18. The thermal management system of claim 11, wherein the first heat exchanger comprises an evaporator (23).

19. The thermal management system of claim 11, further comprising a first coolant circuit (3) passing through the first heat exchanger (23), the first coolant circuit (3) being a low-temperature circuit.

20. The thermal management system of claim 19, wherein the first coolant circuit (3) comprises a cooling water circuit.

21. The thermal management system of claim 11, further comprising:
a second heat exchanger (24); and
a second coolant circuit (4) passing through the second heat exchanger (24), the second coolant circuit (4) being a high-temperature circuit.

22. The thermal management system of claim 21, wherein the second heat exchanger (24) comprises a condenser (24).

23. The thermal management system of claim 11, wherein the valve (22) comprises a shut-off valve, a switch-over valve, or an expansion valve.

24. The thermal management system of claim 23, wherein the valve (22) comprises the expansion valve (22).

25. An expansion valve (22) for the valve (22) of the thermal management system of claim 11, wherein the expansion valve (22) comprises the sensor unit (221) integrated into the expansion valve (22).

26. A motor vehicle, comprising the thermal management system of claim 11.

27. The motor vehicle of claim 26, wherein the motor vehicle comprises an electric vehicle or a hybrid vehicle.

28. A method for managing thermal loads in a vehicle, the method comprising:
providing a first refrigerant circuit (2) comprising a heat pump (1) having at least one compressor (21), a first heat exchanger (23), and a valve (22), the valve (22) comprising a sensor unit (221) integrated into the valve (22);
monitoring data indicative of one or both of a thermal load or a pressure of refrigerant in the first refrigerant circuit (2) via the sensor unit (221); and
controlling the valve (22) via closed-loop control of the first refrigerant circuit (2) based on the data monitored via the sensor unit (221).

29. The method of claim 28, further comprising:
providing a first coolant circuit (3), the first coolant circuit (3) passing through the first heat exchanger (23), the first coolant circuit (3) being a low-temperature circuit; and
circulating a coolant through the first coolant circuit (3) through the first heat exchanger (23).

30. The method of claim 28, further comprising:
providing a second heat exchanger (24);
providing a second coolant circuit (4), the second coolant circuit (4) passing through the second heat exchanger (24), the second coolant circuit (4) being a high-temperature circuit; and
circulating a coolant through the second coolant circuit (4) through the second heat exchanger (24).
